(19) United States
(12) Patent Application Publication
(10) Pub. No.: US 2015/0032563 A1
(43) Pub. Date: Jan. 29, 2015

(54) SYSTEMS AND METHODS FOR ELECTRONIC COMMERCE WITH EXTENDABLE AUCTION PERIODS

(71) Applicant: George Moser, Redwood City, CA (US)

(72) Inventor: George Moser, Redwood City, CA (US)

(21) Appl. No.: 14/339,547

(22) Filed: Jul. 24, 2014

Related U.S. Application Data
(60) Provisional application No. 61/858,049, filed on Jul. 24, 2013.

(51) Int. Cl. G06Q 30/08

(52) U.S. Cl. CPC G06Q 30/08
USPC 705/26.3

(57) ABSTRACT

An electronic commerce auction system is provided. The auction system receives bids during an initial auction period. The auction period can be extended by overtime auction periods. The duration and quantity of overtime auction periods can vary based on criteria such as the number of new bids in the prior period, the cumulative duration of overtime periods, and the amount by which the high bid has increased compared to the close of the prior period.

### TECHNICAL FIELD

The invention is in the field of computer-based electronic commerce methods and systems, particularly those relying on the Internet.

### BACKGROUND

E-commerce has achieved a substantial level of success, with billions of dollars being traded on-line through the Internet every year. J.P. Morgan forecasts that by 2015, e-commerce will reach approximately $1 trillion in worldwide sales revenue. However, a large part of the market remains untapped. E-commerce sales revenue is only about 8% of the total retail sales revenue in the U.S., and an even smaller fraction abroad. This may be largely due to the methodology used by typical e-commerce companies and websites, which have taken out much of the emotion and fun out of the auction process with an inflexible auction model that limits user excitement and also limits the revenue that can be obtained using the current auction formats. Substantial improvements are needed and embodiments of the present invention can address those needs.

The presently named inventor has described other innovative systems and methods related to electronic commerce in co-pending U.S. patent application Ser. No. 13/310,794, filed on Dec. 4, 2011, and U.S. patent application Ser. No. 13/424,309, filed on Mar. 19, 2012. The content of both the aforementioned patent applications is hereby incorporated by reference.

FIG. 1 describes an exemplary prior art methodology used in auctions. In step 10 the seller enters the item(s) for sale in the e-commerce website, including item name, item description, minimum price (if any) and other relevant data about the product to be offered for sale.

In step 12 the seller specifies the SOA (start of auction) and the EOA (end of auction). As will be seen in the next steps of this description of a prior art embodiment, this EOA deadline is typically very inflexible, such as a fixed time and date at which the auction ends. A fixed EOA is advantageous from a website point of view for programming simplicity, but can also impact consumer behavior and system revenue.

In step 13 the auction starts. The auction clock is set at SOA.

In step 14 the ecommerce website waits for bids from users. In step 15 the website receives bids from users and saves them in storage, ranking them in order of highest bid price offered.

The auction clock is checked periodically, and compared with the seller-specified EOA (end of auction). If the current time is not greater than or equal to the EOA, the system loops back to step 14 (wait for bids). If the current time is greater than or equal to EOA (end of auction), the system stops the auction (step 16), and declares as the winner the highest bid (step 18).

In such prior art online auction systems, the rather abrupt action of stopping the auction at a predetermined time can result in an interesting user behavior. Many users try to wait until very close to the end of the auction before making a bid. There is typically a rush of bids in the last few minutes and seconds, and then it's all over. Many users never get to bid the maximum they may have offered if the abrupt end of the auction had not blocked them. The typical end of an auction under the prior art format is one winner and many frustrated potential buyers who didn't get a chance to bid their final offer. This outcome is also not good for the seller, because the seller could in many cases, possibly a majority of cases, realize a higher price if the inflexible ending of the auction would not arbitrarily disqualify many buyers' final offer.

This method also eliminates the human emotion and excitement, and the auction becomes a computer controlled process that is boring, eliminates full competition and leaves both buyers and sellers potentially dissatisfied. A potential buyer who is frustrated by the outcome may not bid next time. A seller who received a lower price than expected may not list a product for sale next time.

There have been some attempts to address these issues but they have not fully succeeded. One of those attempts is an automatic bid feature in some websites that allows the potential buyers to specify a maximum amount they are willing to offer for the item, and then the website will automatically bid up to that maximum in certain increments. This automatic bid feature allows the potential buyer to make his final offer in time and not miss the end of auction deadline. However, the buyer is forced to make the decision about the maximum bid in advance and in absence of any knowledge of the development of the auction. This feature puts the computer completely in control and takes all control away from the buyer, so many buyers are reluctant to use it. Also, the emotion and excitement of an auction is totally eliminated, and that can have a huge effect on the final outcome of an auction. Auctions are based on competition, emotion and excitement, and the prior art format for electronic auctions eliminates those key components of an auction. Embodiments of the present invention can provide a new format for electronic auctions that preserves the global reach of auctions and the efficiency of the process, while further promoting the emotion, excitement and engagement of the bidders.

### SUMMARY

An online auction service is hosted on one or more servers communicating with a plurality of user devices via one or more digital communication networks, such as the Internet, SMS or phone networks. The servers have one or more processors and memory storing instructions which, when executed by the processors, cause the servers to perform methods. The methods include transmitting information describing an item available for auction to one or more of the user devices; monitoring for receipt of bids on the item during an initial auction period from said one or more end user devices; determining whether criteria for extending the auction have been met; and monitoring for receipt of bids on the item from said user devices during one or more overtime auction periods provided said criteria for extending the auction have been met at the inception of each said overtime auction period.

The service may also include receiving information configuring an auction event from a seller of the item, the information including specification of an auction overtime; in which said criteria for extending the auction include the specification of an auction overtime. The information configuring an auction can further include specification of an overtime period duration. Alternatively, the overtime period duration can be determined by the servers. The overtime period duration may be calculated to maximize the expected ultimate bid value, such as via analysis of parameters associated with previously-closed auctions.

One or more criteria can be utilized for extending the auction, such as: whether the number of bids in the preceding auction period exceeds a threshold quantity; a determination of whether the current high bid exceeds a prior high bid by at least a threshold level; and a determination of whether the cumulative number of overtime periods exceeds a threshold number. The duration of subsequent overtime periods may decrease relative to prior overtime periods. Auction term modifications can be introduced during one or more of the auction overtime periods, such as removal of a reserve price and/or reduction in shipping costs.

### BRIEF DESCRIPTION OF THE DRAWINGS

FIG. 1 is a prior art process for conducting an auction using an electronic commerce system.

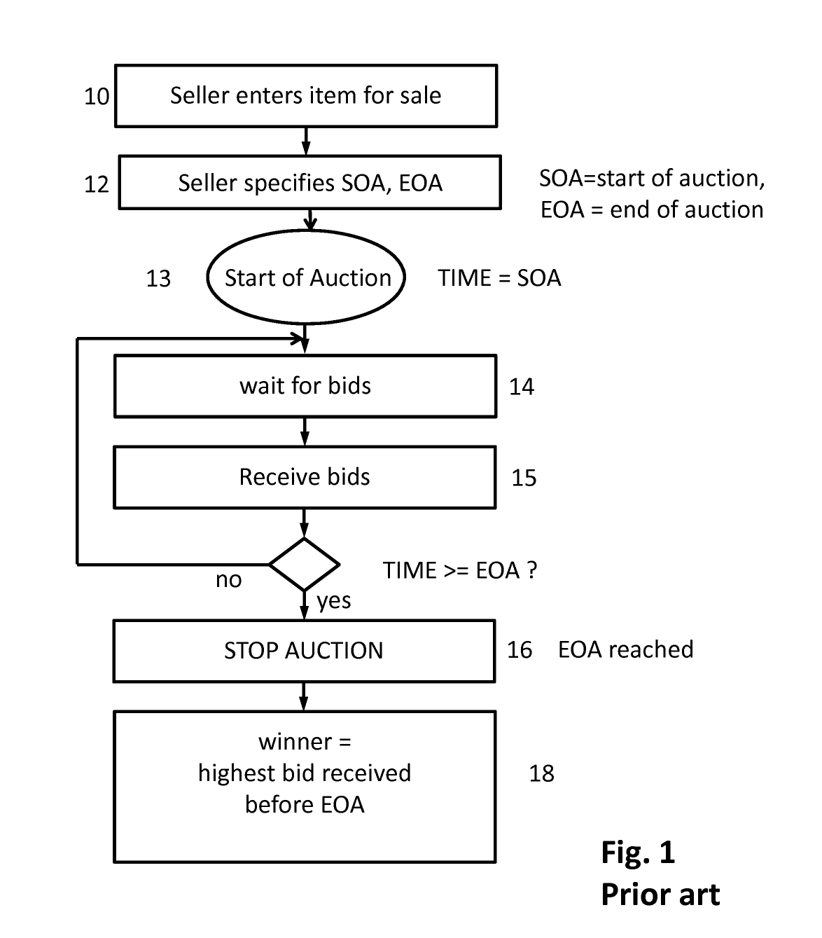

FIG. 2 is a schematic block diagram of an electronic commerce system.

FIG. 3 is a schematic block diagram of participants in an electronic commerce system.

FIG. 4A is process for initiation of an extendable auction within an electronic commerce system.

FIG. 4B is a process for conducting an auction within an electronic commerce system.

FIG. 4C is a process for conducting an overtime period for an auction within an electronic commerce system.

FIG. 4D is an alternative process for conducting an overtime period for an auction within an electronic commerce system, having a maximum cumulative overtime duration.

FIG. 4E is an alternative process for conducting an overtime period for an auction within an electronic commerce system, having decreasing overtime periods and a minimum maximum bid change between subsequent overtime periods.

FIG. 5 is a graphical user interface for conducting an auction within an electronic commerce system.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

The present embodiments introduce a new format for electronic auctions that provides a flexible ending of the auction that maximizes buyer satisfaction, minimizes potential buyer frustration, makes the process fun and exciting and maximizes seller satisfaction as well by potentially maximizing revenue.

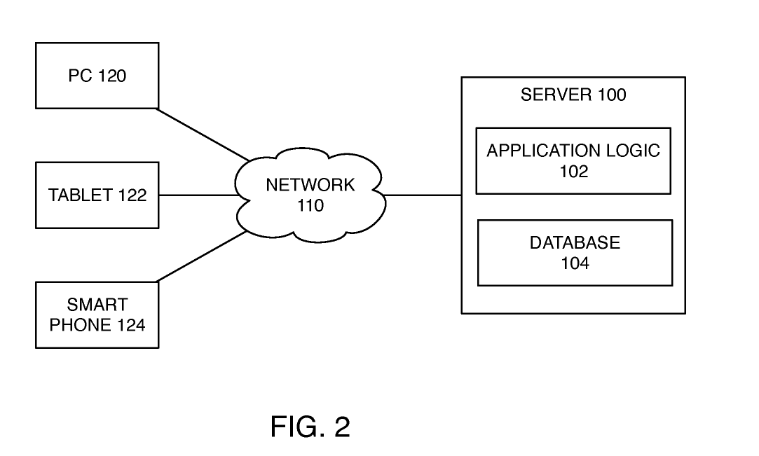

FIG. 2 is a schematic block diagram of an embodiment of an electronic auction system. Server 100 communicates, inter alia, via communication network 110, with user devices such as personal computer 120, tablet computer 122 and smart phone 124. Server 100 implements application logic 102, and operates to store information within, and retrieve information from, database 104. Communication network 110 preferably includes the Internet, and may further include one or more additional communication channels such as SMS and telephone networks.

While depicted in the schematic block diagram of FIG. 2 as a block element, as known in the art of modern web applications and network services, server 100 may be implemented in a variety of ways, via distributed hardware and software resources and using any of multiple different software stacks. Server 100 may include a variety of physical, functional and/or logical components such as one or more each of web servers, application servers, database servers, email servers, SMS messaging servers, Application Programming Interfaces, and the like. That said, the implementation of server 100 will include at some level one or more physical servers, at least one of the physical servers having one or more microprocessors and digital memory for, inter alia, storing instructions which, when executed by the processor, cause the server to perform methods and operations described herein.

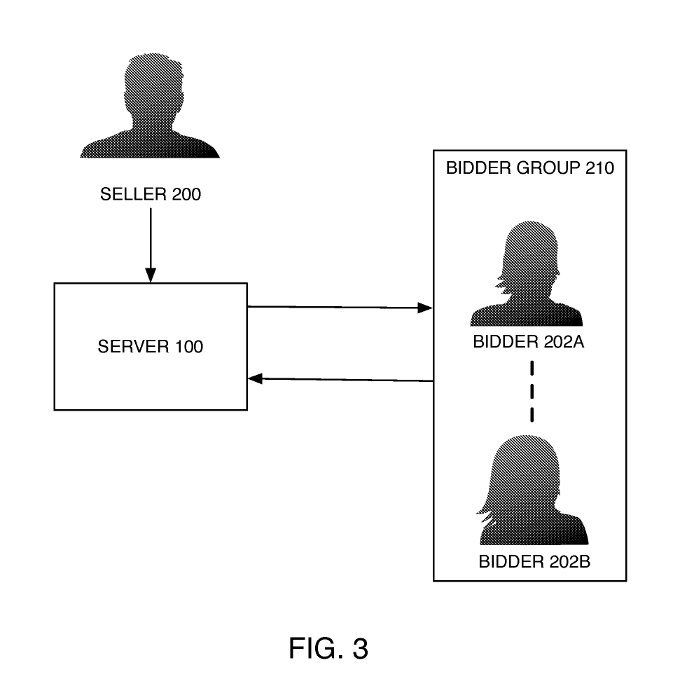

The communication system of FIG. 2, executing application logic 102, can be utilized to implement electronic commerce services amongst a plurality of individuals illustrated in FIG. 3. Such individuals include seller 200, and bidder group 210 which includes one or more bidders 202.

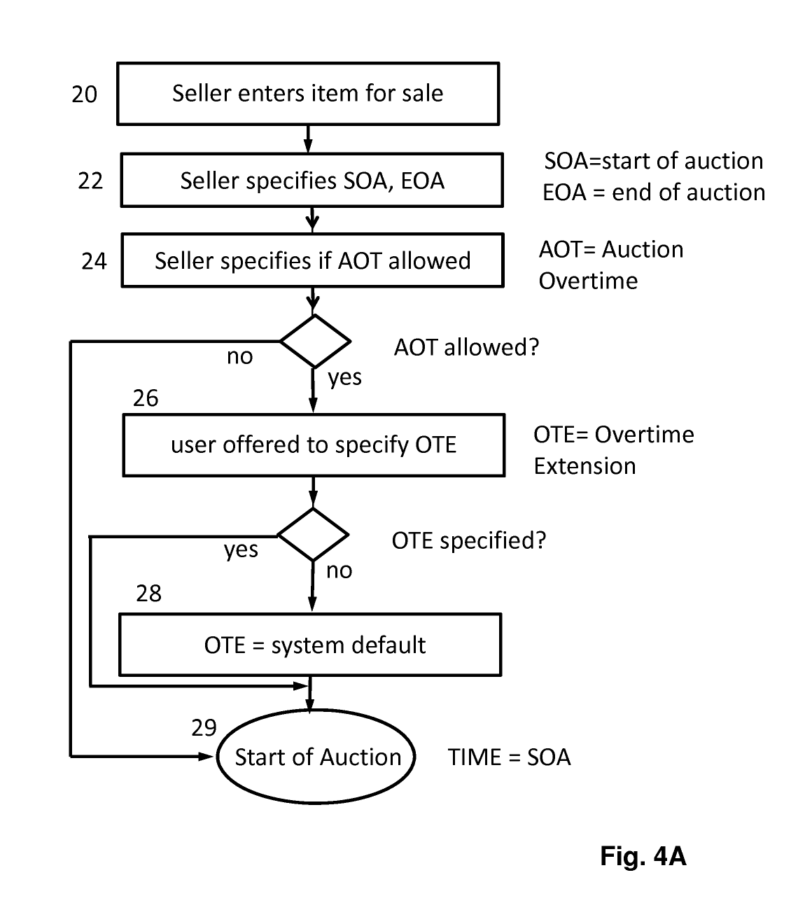

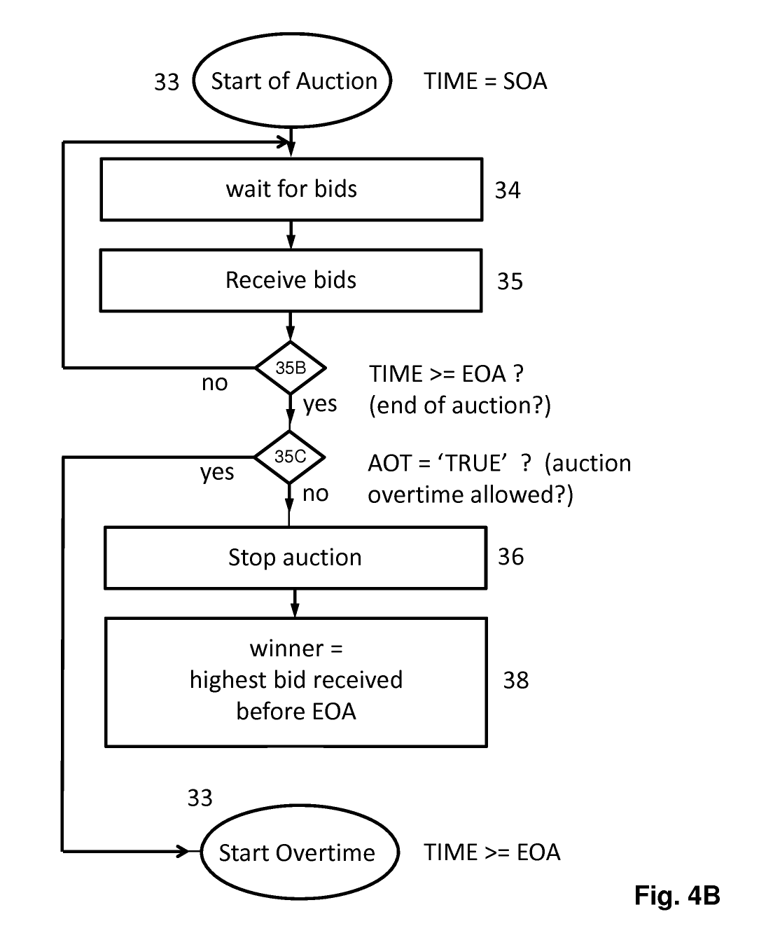

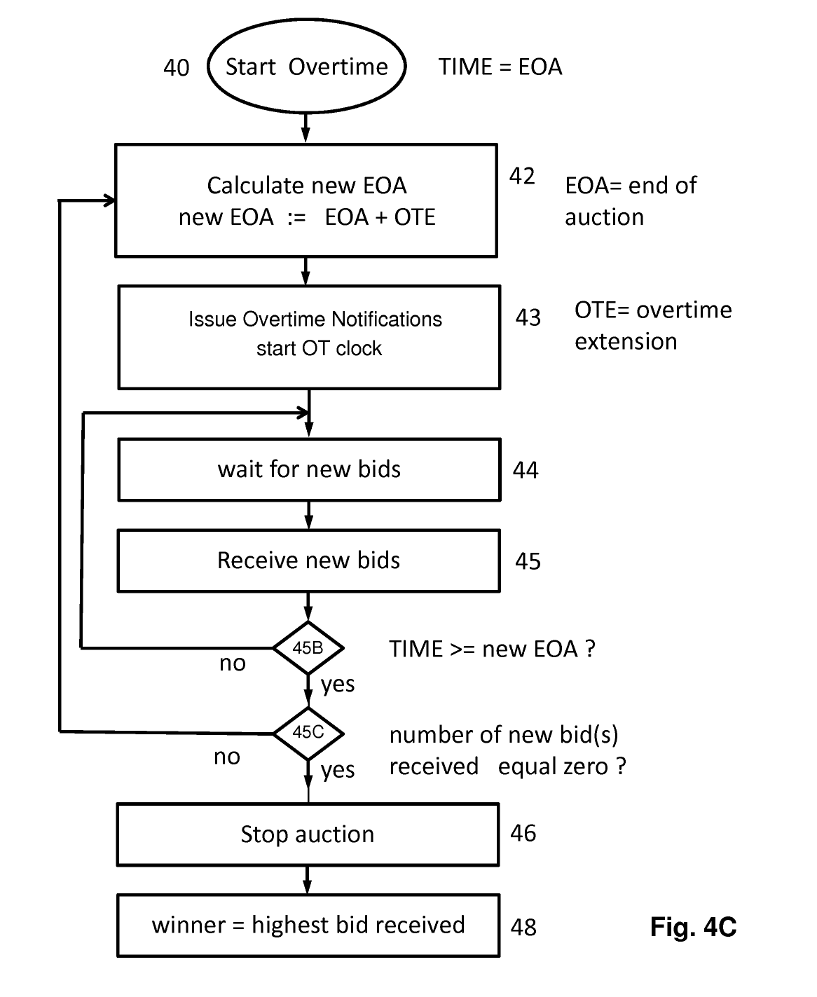

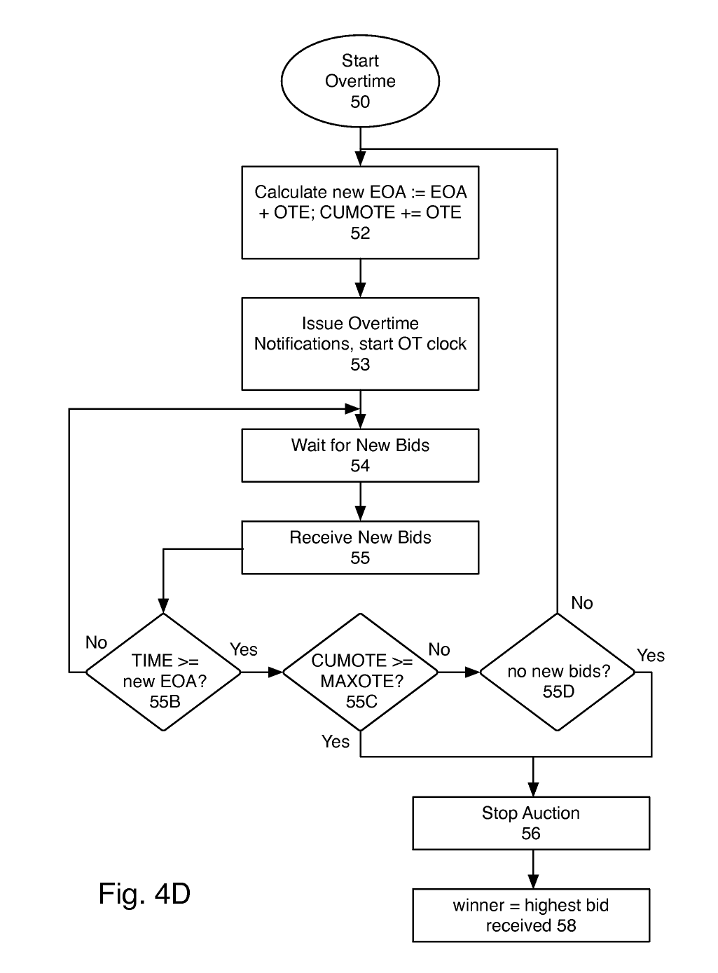

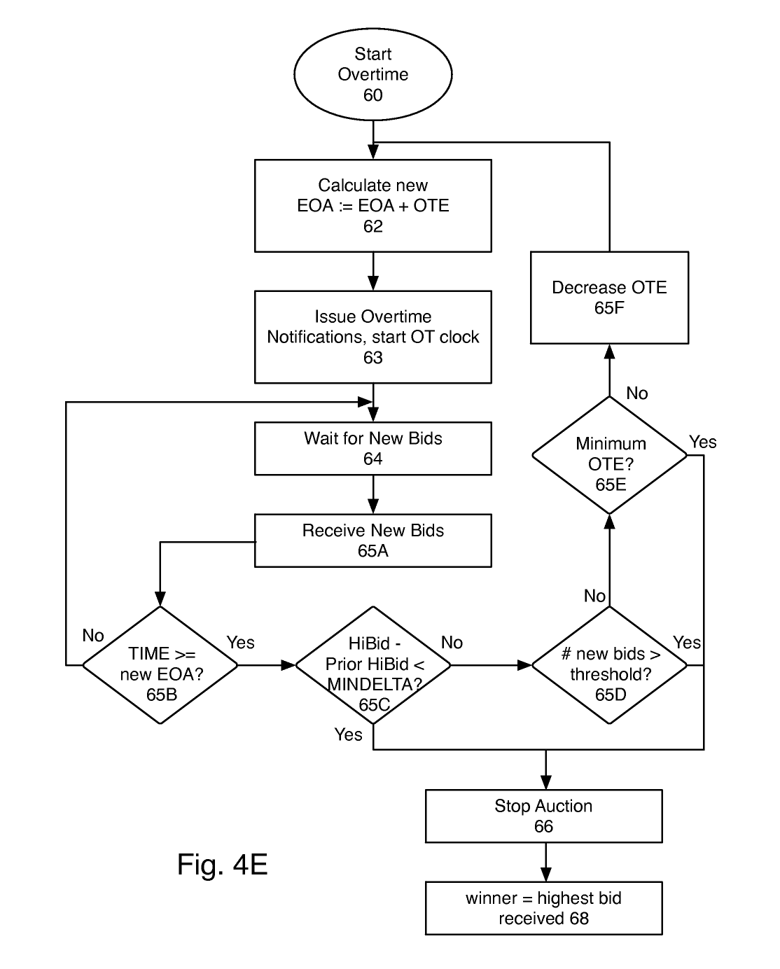

FIG. 4 is a flow chart illustrating an exemplary embodiment of the operation of server 100 and application logic 102, involving the participants of FIG. 3. In step 20 of FIG. 4A, seller 200 enters the item(s) for sale in an e-commerce website presented by server 100, via network 110, and rendered on an end user device such as PC 120, tablet computer 122 or smart phone 124. Alternative, such information could be entered using an application executing on an end user device and interacting with server 100 via network 110. Item information may include things such as item name, item description, minimum price (if any) and other relevant data about the product to be offered for sale, and is stored within database 104.

In step 22, seller 200 specifies the SOA (start of auction) and the EOA (end of auction). As will be explained below, this EOA deadline will not always be interpreted by the system in an inflexible way as it is done in prior art auction formats.

In step 24, seller 200 is asked by the system if he/she wants to allow a flexible auction end format by enabling Auction Overtime (AOT). If seller 200 decides not to enable the flexible format, the system operation jumps to step 29 (Start of Auction). In such a case, the auction will be run in the prior art format having a predetermined end time.

If the seller decides to enable the flexible auction format, the next step is step 26, which asks the seller 200 to specify an Overtime Extension (OTE) period. The OTE period is an amount of time by which the auction will be extended for bids received within the last bidding period, which is described in more detail below. Seller 200 is preferably offered a default value for the OTE in order to keep the process simple (step 28). In his/her first auction with the new system, a seller may use the default system value, in order to learn how the process works in order to specify his/her own preferred OTE value. Therefore the system will provide great flexibility to the seller on how to auction the item, which is important because the optimal OTE for an inexpensive item may be small (maybe 60 seconds) while the optimal OTE for an expensive item may be 60 minutes or more.

If seller 200 specifies an OTE value, application logic 102 jumps to step 29 (Start of Auction).

If seller 200 does not specify an OTE value and accepts the system default, application logic 102 sets the OTE system variable to a default value (step 28) and then proceeds to step 29 (Start of Auction).

FIG. 4B shows the next steps in the flexible auction process of FIG. 4A. In the Start of Auction time, the auction begins (step 33). After the Start of Auction (SOA), the system (i.e. application logic 102) waits for bids (step 34) and receives and records bids from bidders 202 (step 35). Application logic 102 periodically checks the current time, comparing it to the seller-specified End of Auction time (step 35B). If the current time is not less than or equal to the EOA time, the system loops back to step 34 (wait for bids). Once the condition becomes true (i.e. when current time is actually greater than or equal to the EOA time) the system proceeds to the next step 35C, which is to check if Auction Overtime (AOT) is enabled. This can be done by checking the logical value of a Boolean variable called AOT, which is set in step 24. If AOT=NOT TRUE, then the system stops the auction (step 36) and declares the member of bidder group 210 having placed the highest bid as the winner (step 38). However, if the logical variable AOT=TRUE, then the system jumps to step 33 (Start Overtime).

Note that the operational flow of the embodiment of FIG. 4B contemplates automatic initiation of at least one overtime period if AOT is enabled. However, it is contemplated that in other embodiments, additional criteria can be imposed on initiation of overtime. For example, in some embodiments it may be desirable to trigger an overtime period only if a new bid has come in within a predetermined time period of the end of the regular auction period. In such an embodiment, overtime is triggered if there are active bidders near the end of the regular auction period, but the auction would be finalized promptly and without overtime if the auction did not see bidding activity towards its end.

FIG. 4C illustrates the auction process in overtime mode. This is an abbreviated representation of the auction overtime, and certain routine steps and details that would be known to a person of ordinary skill in the art are omitted for clarity; thus, it is understood that variations and additional features could be added without departing from the contemplated scope of the invention.

In step 40, the overtime period begins. In step 42, application logic 102 calculates a new End of Action (EOA) by adding OTE (Overtime Extension) to the previous EOA.

Immediately after that, in step 43 server 100 issues Overtime Notifications to all bidders and to all prospective bidders (such as users registered in a Watchlist maintained for the auction or having the auction registered in the user's Watchlist, or any user who has expressed an interest in this auction during its course), notifying them that the auction has entered Overtime Mode and therefore they still have a brief final chance to bid. Server 100 will publish such warnings via a website, but it can also operate to send emails, text (SMS) messages, Instant Messages, Tweets, Facebook messages and other types of electronic messaging to convey the notification via multiple and/or preferred communication channels. Such notifications may include text such as: “ATTENTION: AUCTION HAS GONE INTO OVERTIME. The Auction has been extended by 2 minutes. The current highest bid is $XX.YY. You can still bid, but HURRY!” (assuming the seller- or system-defined Overtime Extension OTE is equal to 2 minutes; for a multimillion dollar item the extension could be 1 hour, or whatever the seller has pre-selected.)

In steps 44 and 45 the website waits for new bids from members of bidder group 210, and receives new bids, respectively. Application logic 102 periodically checks the current time and compares it to new extended EOA (step 45B). If the current time is not greater than or equal to the new EOA, application logic 102 loops back to step 44 and continues waiting for new bids.

As soon as the new EOA is reached, the system checks the number of new bids received during the extension (step 45C). If that number is zero, then the next steps are step 46 (Stop Auction) and step 48 (declare highest bid as winner).

However, if the number of new bids received during the extension is not zero, the system loops back to step 42 and the auction is automatically extended by the pre-defined OTE (Overtime Extension). New Notifications are sent, containing text such as: “ATTENTION: AUCTION HAS BEEN EXTENDED BY ANOTHER 2 MINUTES due to ongoing activity. The current highest bid is $XX.YY. You can still bid, but HURRY!”

The auction will continue and will be extended as long as there are new bids during the last extension. When bidding stops altogether during an extension, the system finally goes to step 46 and ends the auction. In step 48, the member of bidder group 210 having entered the highest bid is declared as the winner.

The auction system and process described above can act to reduce opportunities for any potential buyer from being cut off. It also increases the potential revenue from the auction by allowing everybody to bid, and by generating potentially intense competition.

To prevent an auction from becoming too long, the seller (or the system default) can define a variable called MAXOTE (Maximum Overtime Extension), which is calculated as the sum of all extensions granted by the system. For instance, a seller can specify that the MAXOTE=1 hour, meaning that the sum of all extensions cannot exceed 60 minutes. When a total extension time of 60 minutes is reached, the auction is ended by the system. This feature prevents small incremental bids from being used to unduly protract an auction. Also, this feature would prevent an automatic software bidding system from intentionally or unintentionally extending an auction to a point of undue delay and customer dissatisfaction.

FIG. 4D illustrates an alternative embodiment of overtime operation implementing a Maximum Overtime Extension. In step 50, overtime operation begins. In step 52, a new EOA is calculated, along with a calculation of the cumulative sum of all extensions granted to date (CUMOTE). Steps 53, 54, 55 and 55B are analogous to steps 43, 44, 45 and 45B in FIG. 4C. Once the new EOA is reached, in step 55C, application logic 102 determines whether CUMOTE exceeds MAXOTE. If so, operation proceeds to Stop Auction step 56, regardless of whether new bids were received in the most recent overtime period. If not, in step 55D, application logic 102 determines whether new bids were received in the most recent overtime period, in which case operation returns to step 52. Once the auction is concluded in step 56, the bidder 202 having the highest bid is determined to be the auction winner (step 58).

Another feature that can be used to prevent excessive extensions is a system variable called MINDELTA (minimum delta, or minimum increment), which is preferably pre-defined by the seller (or by default by the system). MINDELTA can be a dollar amount, or alternatively a percentage of the highest bid at that time. In some embodiments, new bids are accepted only if they meet the minimum increment criterion (for instance, the new bid has to be at least $2 higher than the highest bid, or for a large ticket item: the new bid has to be at least 1% higher than the highest bid). In other embodiments, an overtime extension period may only be activated if the bid has increased by at least a predetermined threshold amount during the most recent overtime period. These mechanisms can be used to control the total duration of the auction.

A mechanism to increase suspense and excitement is to use a system variable called DYNOTE (Dynamic Overtime Extension). In one type of embodiment, the Dynamic Overtime Extension can be used to define a decreasing overtime extension period. For instance, the first extension can be 4 minutes, the next only 2 minutes, then 1 minute, then 30 seconds, then 15 seconds.

FIG. 4E illustrates an exemplary overtime process executed by application logic 102 to implement a MINDELTA criterion for continuation of auction overtime, as well as a dynamic overtime extension and threshold minimum bid volume. Steps 60 through 65B, 66 and 68 operate analogously to FIG. 4D. However, in step 65C, a determination is made as to whether the current high bid amount minus the high bid amount at the close of prior overtime period is less than a MINDELTA value specified by seller 200 or calculated by application logic 102. If so, the auction is stopped, regardless of whether new bids were received during the most recent overtime period (step 66). In step 65D, a determination is made as to whether the number of new bids in the prior auction period exceeds a threshold quantity, which threshold could optionally be zero or configured to a higher number, whether by specification of seller 200 or by determination of application logic 102. If not, the auction is stopped (step 66). If so, in step 65E, a determination is made by application logic 102 as to whether the last overtime extension period met or fell below a minimum threshold overtime extension duration. If so, the auction is stopped (step 66). If not, the OTE period is decreased in step 65F, before operation returns to step 62 to calculation a new End of Auction time.

In other embodiments, the length of a dynamic overtime extension can be dependent on other factors. In one such application, a computer system can be configured to calculate correlation between various parameters for prior closed auctions in order to automatically optimize the auction format, using methods such as machine learning, linear regression or others. Information regarding prior closed auctions can be stored within database 104 for such analysis. If a correlation is identified between overtime extension period and likelihood of eliciting a subsequent bid, the overtime extension period can be automatically optimized to maximize bidding activity. Correlations may also be sought with ultimate maximum bid. Auction parameters that can be considered for correlation and/or optimization include one or more of: overtime extension period length, the number of elapsed extension periods, the current bid price, the nature of the item under auction, the minimum bid increment, the number of active bidders, time and date. These and other dynamic variations in auction parameters are contemplated in accordance with various embodiments of the present invention.

Embodiments of the new electronic auction format may also include automated bidding for buyers who cannot physically participate in the auction at the time of the auction. Such an automated system would allow buyers to enter a maximum bid for the regular auction and a second maximum if the auction goes into overtime.

Other embodiments of the auction system described herein enable seller 200 to introduce auction term modifications (typically buyer-favorable modifications) during overtime periods to incentivize further bidding. For example, seller 200 may remove a reserve price during an overtime period, should the reserve not yet be met. Other potential dynamic auction term modifications include a reduction in minimum bid increment, introduction of a free shipping offer, or combinations of multiple such modifications.

Another feature that may optionally be implemented in connection with embodiments of the invention is a graphical screen that displays the auction participants as animated icons or small images congregated around a bid scoreboard and a large ticking clock that shows the time left, overtime period, etc. The particular user is shown in a different color for easy identification. Each bid is shown as the icon or image raising its hand and generating a bid that goes into the score board. This type of graphical bidding screen can create an environment similar to a game or actually any other setting that users like. The system can provide different flavors of the graphical bidding screen, such as: imitation of a baseball or football stadium, imitation of a stock market, imitation of a city marketplace, imitation of a concert place, etc., and the user can set his preferences to choose the type of setting he or she would like to see, from the very plain and conservative to the very imaginative and playful.

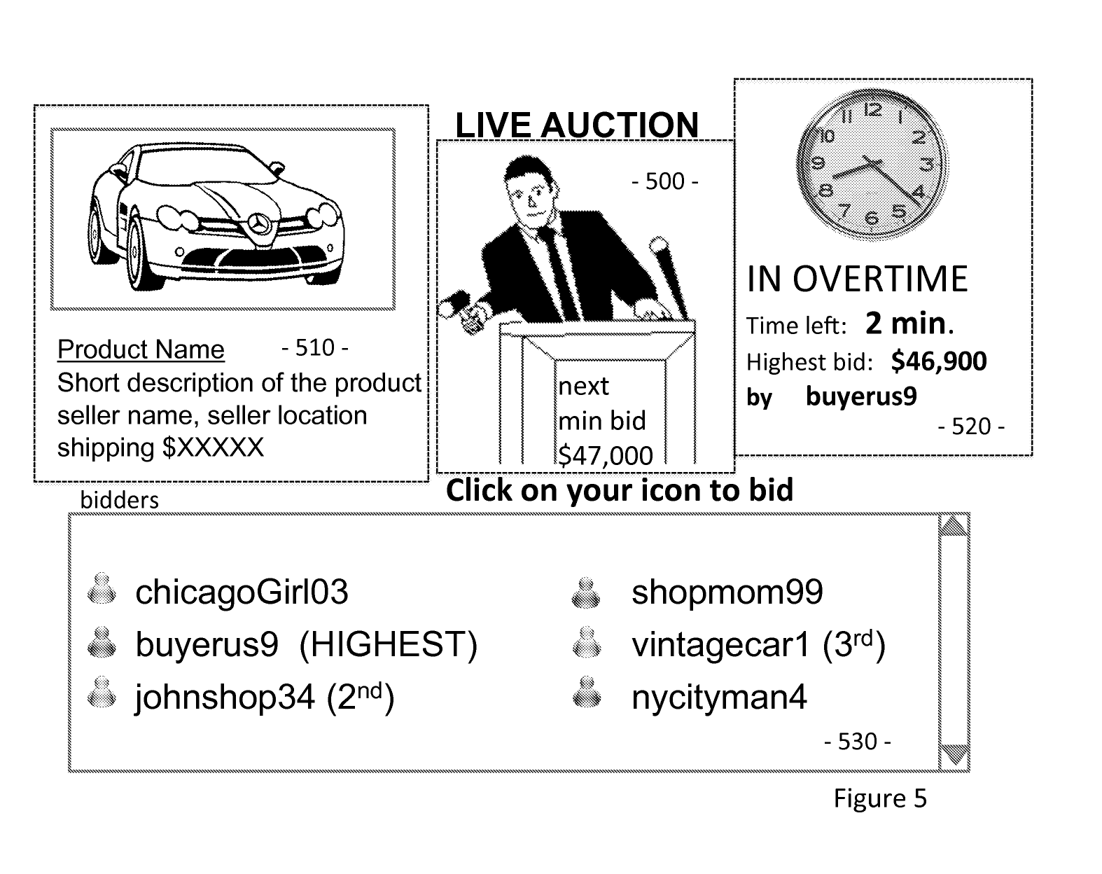

FIG. 5 illustrates a graphical auction participant interface in accordance with one potential embodiment. The interface of FIG. 5 is rendered on user devices (such as PC 120, tablet 122 or smart phone 124) communicating with server 100 via network 110, such as via a web browser operating on a user device and communicating with a web server implemented within server 100, or via a standalone application downloaded to and executing on the end user device and communicating with server 100 via network 110.

Region 500 provides a graphical representation of an auctioneer. Exemplary implementations of region 500 include a static image, an animated image, an icon, an avatar, a photo of a person, or a video recording of a person conducting an auction. In embodiments having animated graphics within region 500, the animation can optionally be adaptive, such that it reacts to auction events such as placement of bids, clock status and auction time extensions. Graphics within region 500 may optionally be accompanied by associated audio content; for example, an animated graphic of an auctioneer can be accompanied by voice over audio content announcing bids and time remaining.

Region 510 displays information about the item under auction.

Region 520 displays information concerning the status of the auction, such as whether the auction is in overtime, the time remaining in the current overtime extension period, and the current high bid.

Region 530 displays representations of active bidders in the present auction. In the embodiment of FIG. 5, each bidder is represented by an icon and username. However, it is contemplated that in other embodiments, users may be represented by other representations, such as avatars or photographs. The nature of a bidder's representation in region 530 may also convey information concerning the bidder, such as identifying the current highest bidder, or a “Master Bidder” designation indicating a bidder's experience level or success rate in prior auctions.

In some embodiments, it may also be desirable to provide communications tools enabling bidders to communicate with each other and/or the auctioneer, thereby potentially heightening user excitement and competition. Communications tools may include instant message, video message, voice communications and/or video chat. Preferably, communications are implemented via client computer web browser accessing a common auction system web application server. However, it is also contemplated that communications can be implemented by direct activation of third party services, such as messaging applications, Skype, Google+ Hangouts and the like.

While certain system infrastructure elements are illustrated in particular configurations, it is understood and contemplated that functional elements described herein can be readily integrated and/or implemented via various alternative hardware or software abstractions, as would be known to a person of skill in the field of information systems design. For example, while some of the above described embodiments include or describe presentation of content via a web browser, it is contemplated and understood that a standalone PC application, or a smart phone or tablet computer app, could be implemented in order to present content as described hereinabove. These and other variations are contemplated.

Moreover, while certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

What is claimed:

1. An online auction service hosted on one or more servers communicating with a plurality of user devices via one or more digital communication networks, the servers having one or more processors and memory storing instructions which, when executed by the processors, cause the servers to perform a method comprising:
transmitting information describing an item available for auction to one or more of said user devices;
monitoring for receipt of bids on the item during an initial auction period from said one or more end user devices;
determining whether criteria for extending the auction have been met;
monitoring for receipt of bids on the item from said user devices during one or more overtime auction periods provided said criteria for extending the auction have been met at the inception of each said overtime auction period.

2. The online auction service of claim 1, in which the method further comprises a preceding step of receiving information configuring an auction event from a seller of the item, said information including specification of an auction overtime; in which said criteria for extending the auction include the specification of an auction overtime.

3. The online auction service of claim 2, in which the information configuring an auction further includes specification of an overtime period duration.

4. The online auction service of claim 1, in which the criteria for extending the auction further includes whether the number of bids in the preceding auction period exceeds a threshold quantity.

5. The online auction service of claim 1, in which the criteria for extending the auction further includes a determination of whether the current high bid exceeds a prior high bid by at least a threshold level.

6. The online auction service of claim 1, in which the criteria for extending the auction further includes a determination of whether the cumulative number of overtime periods exceeds a threshold number.

7. The online auction service of claim 1, in which the duration of each auction overtime period decreases relative to a prior auction overtime period.

8. The online auction service of claim 1, in which the method further comprises the step of introducing one or more auction term modifications during one or more of said auction overtime periods.

9. The online auction service of claim 8, in which said auction term modifications include removal of a reserve price.

10. The online auction service of claim 8, in which said auction term modifications include reduction in shipping costs.

11. The online auction service of claim 1, in which the service further comprises a database storing parameters associated with a plurality of previously-closed auctions, the method further comprising the step of calculating an overtime period duration by said servers anticipated to maximize the expected maximum bid via correlation in prior auctions between said prior auction parameters and maximum bid.
